(19) United States
(12) Patent Application Publication
(10) Pub. No.: US 2015/0027791 A1
(43) Pub. Date: Jan. 29, 2015

(54) Vertical Load Weighing Station for Large Machinery Guide Systems

(71) Applicants: Tino Oldani, Rockford, IL (US); Giovanni B. Bonomi, Medinah, IL (US)

(72) Inventors: Tino Oldani, Rockford, IL (US); Giovanni B. Bonomi, Medinah, IL (US)

(73) Assignee: Ingersoll Machine Tools, Inc., Rockford, IL (US)

(21) Appl. No.: 14/335,191

(22) Filed: Jul. 18, 2014

Related U.S. Application Data
(60) Provisional application No. 61/857,877, filed on Jul. 24, 2013.

(51) Int. Cl. G01G 19/52; G01G 19/62; F16C 41/02

(52) U.S. Cl. CPC G01G 19/52; F16C 41/02; G01G 19/62
USPC 177/132; 29/428

(57) ABSTRACT

A vertical load weighing system and method are provided. The system includes a rail and a plurality of trucks slidable on the rail. The plurality of trucks support a saddle that carries a portion of a machine. A load measuring means is situated underneath a portion of the rail and is operable to sense the loading of each truck from the saddle and its associated machinery. The load measuring means is in operable communication with a controller that collects the sensed loading from the load measuring means. The controller is operable to provide an output indicative of the loading of each truck to allow an operator to dimensionally adjust each truck to achieve a balanced loading across the plurality of trucks.

CROSS REFERENCE TO RELATED PATENT APPLICATIONS

This patent application claims the benefit of U.S. Provisional Patent Application No. 61/857,877 filed Jul. 24, 2013, the entire teachings and disclosures of which are incorporated herein by reference thereto.

### FIELD OF THE INVENTION

The present invention relates to the field of machine tools and more precisely to guiding systems for large machinery.

### BACKGROUND OF THE INVENTION

Modern large envelope machines such as machine tools, positioners, telescopes, and the like are nowadays equipped with guiding systems comprising a rail and a plurality of sliding trucks each carrying inside a multiple number of recirculating rolling elements such as balls or rollers to allow a smooth sliding. The trucks commonly support a portion of the machine such that movement of the trucks along the rail results in movement of the portion of the machine supported thereby.

The size of the rail and the number of trucks are typically selected based upon static/dynamic loads of the machine. Indeed, large envelope machines are often equipped with a tangible number of trucks sliding on one rail and mounted one next to another in order to carry the requested static and dynamic loads while meeting the requested life expectations of the system.

This modern guiding system provides an efficient and modular solution for large machinery and often out performs previous technologies such as hydrostatic systems which are more complicated to manufacture and apply considerable energy loss due to the need of continuously pumping hydraulic oil through the system. The above-described trucks are capable of translation on linear and/or curved rails, offering an outstanding rigidity, reliability and low friction.

Large envelope machinery often requires a large number of trucks operating one next to another in order to carry large loads. Due to high individual rigidity and load distribution, often the trucks typically suffer a non-uniform uneven vertical load distribution wherein some trucks may be subjected to vertical loads quite higher than others. This abnormal condition will cause a major life reduction of the overloaded truck which eventually will induce rail damage resulting in the need of an early replacement of the entire system, i.e. at least the rail and the damaged trucks.

In order to minimize the substantial relative difference of vertical loads among the trucks, each truck is typically equipped with a shim mounted on top of the truck. The operators will precisely grind the thickness of the shim in order to obtain a good load sharing and avoid single truck overloads, i.e. load peaks on any one particular truck.

Unfortunately while this “load sharing” procedure of grinding the shim is fairly simple on small structures, it becomes extremely difficult as the size of the machine grows because of the number of cooperating trucks. This ultimately makes the procedure practically impossible for machine structures exceeding 2 meters that are translated by the trucks, and/or vertical loading over 20 tons. Further, the above procedure is also very difficult where the number of trucks is over ten. It is important to note that the load sharing must provide compensation for uneven loads, component geometrical errors, structure deflections, and/or uneven height of the trucks.

The typical rigidity of each truck can easily reach the value of one ton/micron, which means that a difference in height of only 5 microns between 2 trucks next to each other can generate an extra load of 5 tons which consumes a tangible portion of the truck payload and will negatively affect the truck life up to 5 times.

One approach is to equip each truck with a load measuring device in order to provide an accurate readout of each individual truck load. However equipping each truck with a load measuring device would become extremely complicated, expensive and not practical. Additionally a load measuring device such as a load cell would require an object displacement in order to read the load and this would become a tangible loss of rigidity of the system.

FIGS. 1A-1B show such a conventional approach for providing the vertical load indication of each truck by providing a load cell LC1, LC2, LC3 with each individual truck T1, T2, T3. In FIG. 1A, a bed section 1 usually solidly anchored to the floor supports a rail 2 upon which a plurality of sliding trucks Ti, T2, T3 are situated next to each other.

An adjusting device 3, in the figure comprising an adjustable double wedge 3A and 3B (see FIG. 1B) but most commonly simply a solid shim to be adjusted by precision grinding to a desired thickness provides the means to bring each individual truck T1, T2, T3 to its appropriate height to achieve the above described load sharing.

A load cell carrier 4 is mounted interposed between each truck T1, T2, T3 and a saddle 5 and provides a housing for each load cell LC1, LC2, LC3. This system does provide a good measurement of the vertical load carried by each truck T1, T2, T3 beneath but it is inevitably introducing a tangible loss of rigidity as the load cell carrier 4 has to deform vertically in order to allow the load cell to read properly as a load cell is a transducer that converts a vertical deflection/displacement in an electric signal that is amplified and transmitted to a display. This loss of rigidity, by itself, makes the system unusable in large envelope, high accuracy machinery. Additionally, the load cell may lose its pre-setting and in a system with dozen of load cell carriers, and as such, the system has proven to be expensive and not reliable.

Accordingly, there is a need in the art for a system and method for determining the loading upon each individual truck to allow for precise shim adjustment to substantially reduce the relative differences in loading across the individual trucks.

The invention provides such a system and method. These and other advantages of the invention, as well as additional inventive features, will be apparent from the description of the invention provided herein.

### BRIEF SUMMARY OF THE INVENTION

One aim of the present invention is to provide a rail integrated vertical load measuring system capable of accurately measuring a load of each truck sliding on it. From this measurement, a load map can be generated that will determine the optimal shim thickness for each truck.

An aim of the present invention is to provide a measuring system which will remain permanently integrated in the guiding system without effecting the system rigidity and or precision thereof

The measuring system herein is based on the new concept of integrating a measuring device located underneath a segment of rail which will act as weighing station capable of reading the vertical load applied to every single truck as it is positioned on that segment of the rail.

In one aspect, the invention provides a vertical load weighing station for a guide system. An embodiment of such a weighing station includes a machine bed and a rail mounted to the machine bed. The rail is configured to slidably support one or more trucks which in turn are configured to support a saddle of a machine. At least one load cell is positioned under the rail to detect a vertical loading upon the one or more trucks when the one or more trucks are positioned vertically above the load cell on the rail.

In another aspect, the invention provides a vertical load weighing station for a guide system. An embodiment of such a weighing station includes a machine bed and a segmented rail mounted situated above the machine bed. At least one load cell is disposed between a segment of the segmented rail and the machine bed. The at least one load cell is operable to detect a vertical loading exerted upon the segment of the segmented rail.

In certain embodiments, the rail is segmented such that it has at least a first and a second segment. The at least one load cell is situated in a cavity formed in the machine bed and wherein the at least first and second segments are separate components separated from one another by an air gap. The air gap is approximately 1 mm thick.

In certain embodiments, the first segment has slot formed in a bottom surface thereof to form a hinge between a first sub-portion and a second sub-portion of the first segment. The second sub-portion is angularly rotatable about the hinge relative to the first sub-portion. The slot extends from the bottom surface of the rail and terminates prior to the top surface of the rail. The slot may extend greater than half of an overall height of the rail.

In certain embodiments, a shim is situated under the at least one load cell within the cavity. The shim configured such that the at least one load cell is vertically adjustable relative to the rail. The at least one load cell is vertically adjustable by the shim such that the load cell is operable to bias an end portion of the rail to a biased position higher than an unbiased position of the rail relative to the machine bed.

In certain embodiments, the at least one load cell includes two load cells situated on top of the machine bed and below the first segment of the rail.

In yet another aspect, a method for assembling a vertical load weighing station for a guide system is provided. An embodiment of such a method includes the step of positioning at least one load cell beneath a rail mounted to a machine bed such that the at least one load cell is disposed between the rail and the machine bed. The rail is configured to slidably support one or more trucks which in turn are configured to support a saddle of a machine. The at least one load cell is positioned under the rail to detect a vertical loading upon the one or more trucks when the one or more trucks are positioned vertically above the load cell on the rail.

In certain embodiments, the method may also include the steps of removing an existing portion of the rail to expose a portion of the machine bed, situating the at least one load cell on the machine bed, and replacing the existing portion of the rail such that the rail presents a generally continuous guide surface for guiding the one or more trucks.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1A-1B illustrate a conventional truck and rail system with a load cell integrated into each individual truck;

FIG. 2 is a representation of one embodiment of a vertical load weighing station according to the teachings of the present invention;

FIG. 3A-3D illustrate an alternative embodiment of the weighing station of FIG. 2; and

FIGS. 4A and 4B show exemplary load measurement plots taken by the system described herein.

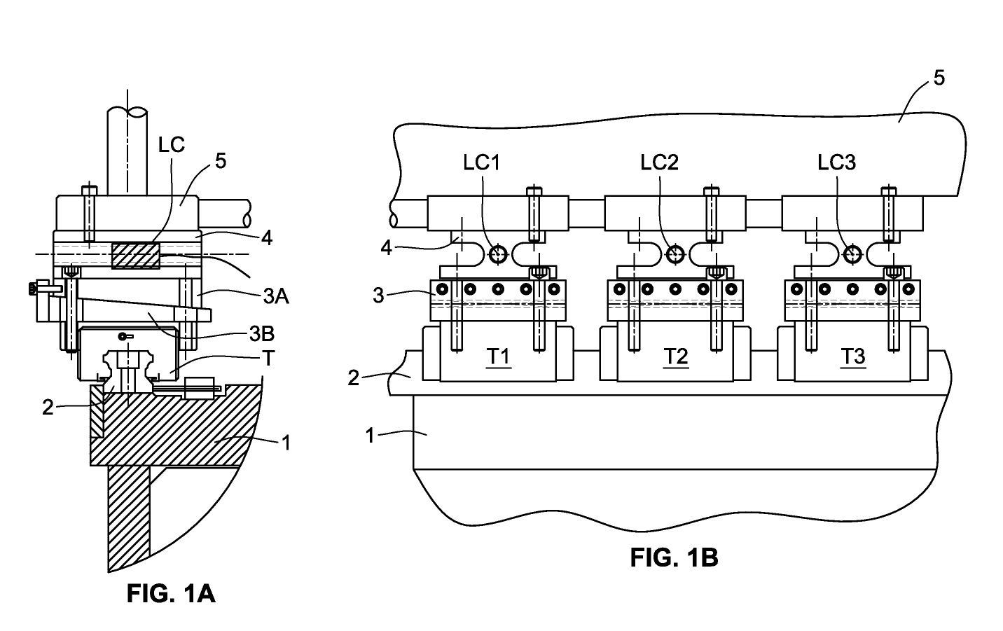

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

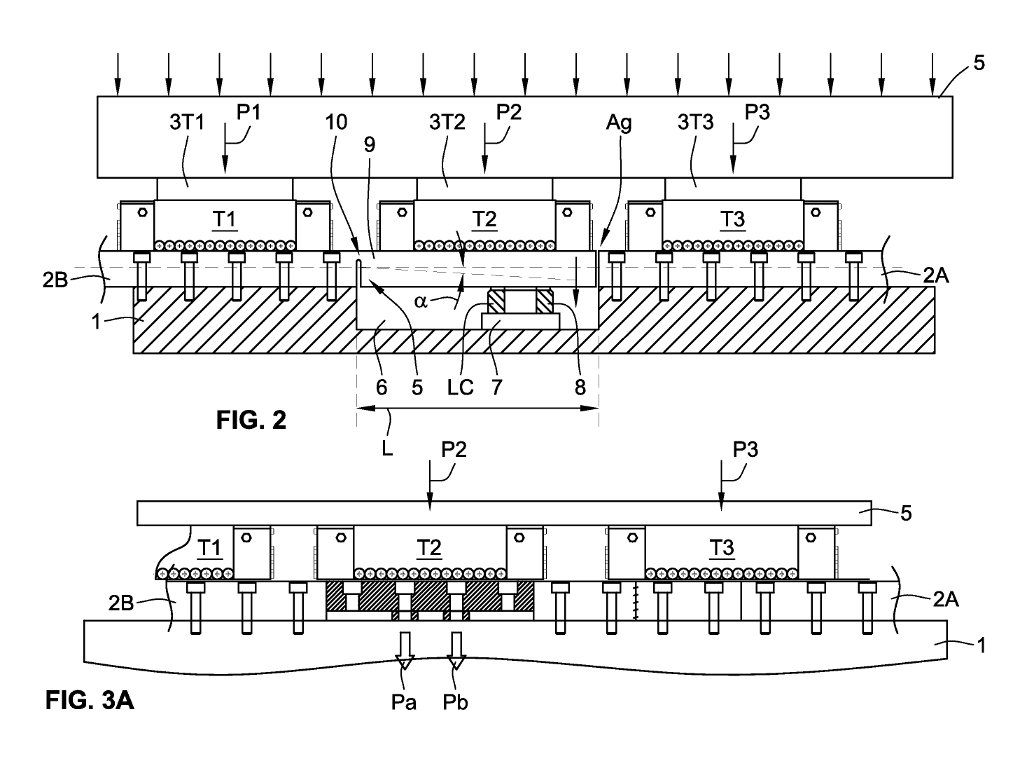

FIG. 2 shows one embodiment of the weighing station according to the present invention wherein a machine bed section 1 supports two rail segments 2A, 2B which are mounted one next to another with a small air-gap AG separating them. A plurality of trucks T1, T2, T3 are slidable on rail segments 2A, 2B. The air-gap AG may be up to 1 mm in one non-limiting example, and it is perfectly tolerated as the sliding trucks T1, T2, T3 may have multiple sliding elements inside and they can smoothly cross through limited air gaps without reducing rigidity nor accuracy. The particular number of trucks T1, T2, T3 is not in any way limiting on the invention, and fewer or greater trucks may be utilized. The trucks T1, T2, T3 carry the vertical and transversal load of the translatable machinery. This machinery is situated on a saddle 5 that is supported by the trucks T1, T2, T3. Each truck T1, T2, T3 includes a vertical adjusting means 3T1, 3T2, 3T3, respectively, which may take on a variety of forms, and as one example, may be a shim.

The machine bed section 1 comprises a cavity 6 of a desired width L engineered to house a load cell LC, integrated in the system and functions to read the deflection D of the end portion 9 of the rail segment 2B as result of a truck, and in FIG. 2 particularly truck T2, being temporarily located on top of rail segment 2B at end portion 9 over said cavity 6. Load cell LC is in operable communication with a controller to collect and/or interpret readings taken by load cells LC1, LC2. A shim 7 may also be mounted below the load cell LC to offer a precise vertical adjustment of the load cell underneath end portion 9.

Accuracy of the system can improve if rail segment 2B is “hinged” in the position 10 by cutting for example cutting a slot S in the bottom portion of the rail segment 2B leaving untouched the upper portion of the rail which offers a multiple raceway for the truck rolling elements. Such an improvement by way of slot S is helpful but not necessary.

When the machine is moved in a position wherein truck T2 is located on top of the cavity 6, the load P2 at truck T2 causes a rotation a of the rail segment 2A and particularly end portion 9 and a vertical deflection D, allowing the load cell LC to produce a signal proportional to the load P2.

Load cell LC features a rigidity large enough to allow P2 measuring within a deformation D which is seen as a step when the machine moves longitudinally that is tolerable from the sliding elements of each truck T1, T2, T3. Additionally, shim 7 can bring the upper edge of end portion 9 slightly higher than its nominal position in order to bring the starting point of the displacement D from a positive value to a negative value thus minimizing said step.

The machine is firstly assembled with all shims 3T1, 3T2, 3T3 having the identical thickness but due to a plurality of contributions such as uneven load distribution on saddle 5, inevitable geometrical errors, inevitable deflection of the machine structures and slight inconsistence of truck height, the loads P1, P2, P3 on trucks T1, T2, T3 can be initially substantially different and consequently reach for some trucks a vertical load values far above the average value while other trucks will carry only a fraction of what they could. This can greatly reduce the guiding system life and/or induce truck failure.

The above described weighing station will one-by-one provide a load map essential to adjust each shim 3T1, 3T2, 3T3 height in order to compensate in one single adjust all the negative effects causing uneven vertical loads among the trucks.

It is important to observe that for a good shim adjustment (i.e. load sharing) it is not important to have an exact numerical value of the vertical load but it is rather important to measure the difference of loads existing among the trucks. In fact, the numeric average load is usually known while the goal remains to find a valuable means to provide indications on how much each shim 3 need to be adjusted in order to achieve a good load sharing (shim thickness map). Based on said indications, each shim is then corrected accordingly and the load P of each truck T1, T2, T3 measured again to double check how the truck load distribution is after the shim 3T1, 3T2, 3T3 corrections. The difference of load among the blocks is typically generated by the multiple contributions including but not limited to inconsistent block height, unsymmetrical loading, geometric error of the machining of the machine structures, structure deflection. As result, utilizing the rail and load cell configuration described above advantageously reduces or eliminates machine rigidity loss, reduces or eliminates machine accuracy loss, allows for sufficiently precise definition of the shim thickness map, allows for vertical overload peak shaving, and provides for easy adjustment of each shim as the above referenced load map allows for a precise determination of the adjustment of each shim. It is contemplated that load cell LC will permanently remain in cavity 6 so that subsequent load maps may be developed during the service life of the machine for future shim adjustment as needed.

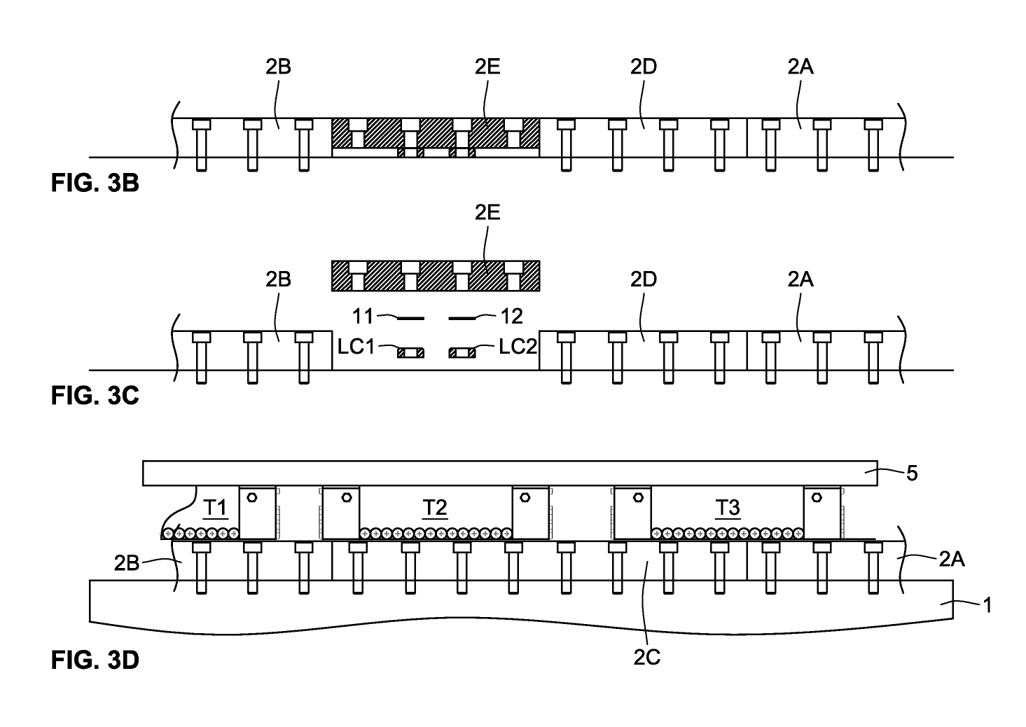

FIGS. 3A-3D show an alternative embodiment of the weighing station according to the present invention wherein a rail segment 2C is temporarily replaced by a solid element 2D and a modified segment 2E which allocates room to provide a load cell LC1 and LC2 mounted underneath segment 2E, which are in operable communication with a controller to collect and/or interpret readings taken by load cells LC1, LC2. In such arrangement, the above load cells LC1, LC2 can precisely measure the load on each truck, and particularly load P2 on truck T2 in FIG. 3, providing the values Pa and Pb. The system shown in FIG. 3 may be utilized in existing machines that may not incorporate a cavity 6 as shown in FIG. 2. The system shown in FIG. 3 may be temporarily emplaced to develop a load map for shim adjustment, or may remain permanently in place.

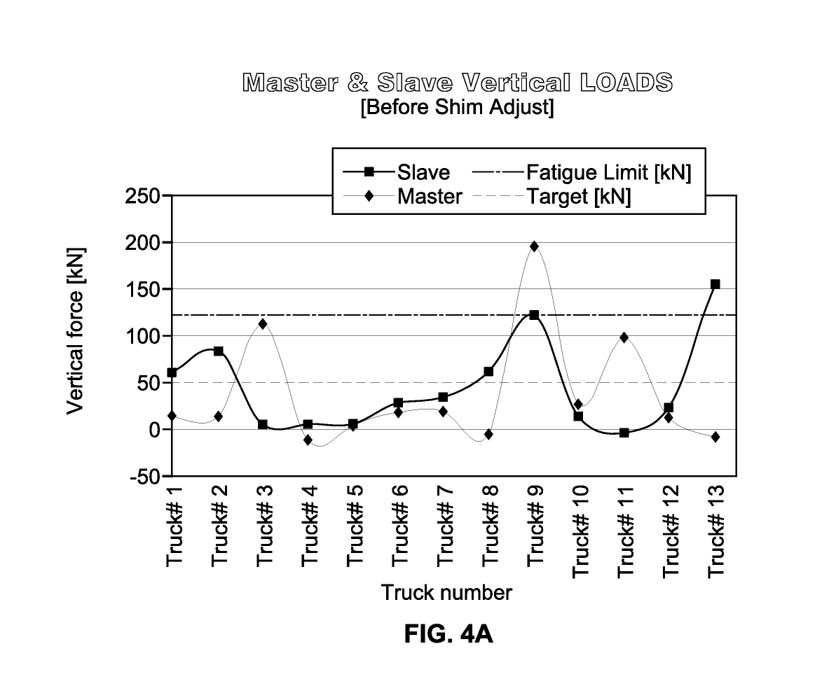

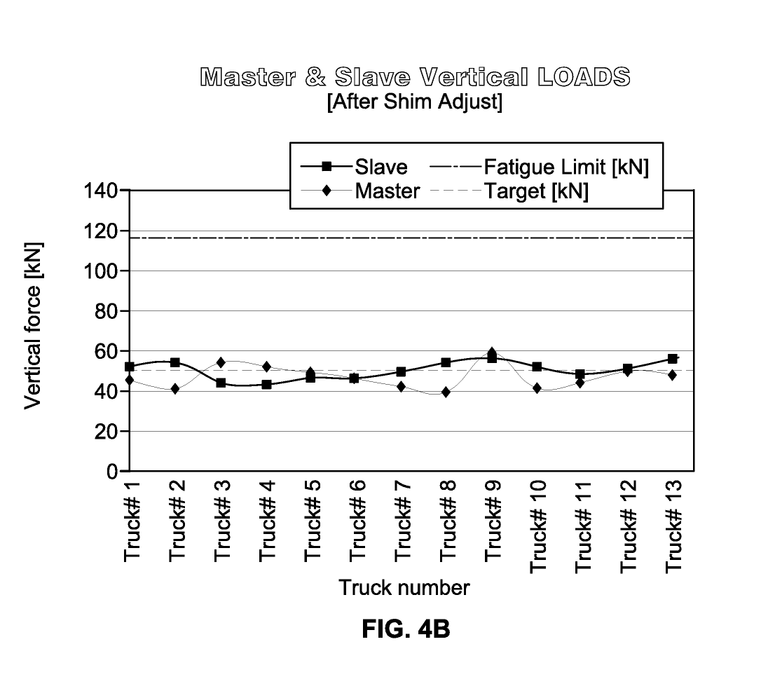

FIG. 4A provides a printout of from the weighing station as described above relative to FIGS. 2 and 3 of readings taken from each truck of a plurality of trucks supporting saddle 5 and its associated loading. Given that the optimal configuration would be the one where all trucks carry the same load (each value equal or very close to the average calculated as total load/number of trucks) and the curve consequently flat, the chart of FIG. 4A clearly indicates an abnormal load distribution of the vertical loads, in particular shows the truck no. 3 and truck no. 9 are severely overloaded (vertical load far larger than the mean load) while trucks 4, 8 and 13 carry a load far below the average.

The chart of FIG. 4A thus provides the key information to the assembler which will then grind the shims for each truck accordingly in order to achieve a configuration where each block will carry a load very close to the average load thus removing any undesired overload and consequently bringing the system toward the optimal working condition and the maximum operating life. After such grinding, subsequent readings are taken as shown in FIG. 4B to ensure the fidelity of the grinding process. As can be seen in FIG. 4B, the relative difference in loading for each truck is minimized substantially.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vertical load weighing station for a guide system, the weighing station comprising:
a machine bed;
a rail mounted to the machine bed, the rail configured to slidably support one or more trucks which in turn are configured to support a saddle of a machine;
at least one load cell positioned under the rail to detect a vertical loading upon the one or more trucks when the one or more trucks are positioned vertically above the load cell on the rail.

2. The weighing station of claim 1, wherein the rail is segmented such that it has at least a first and a second segment.

3. The weighing station of claim 2, wherein the at least one load cell is situated in a cavity formed in the machine bed and wherein the at least first and second segments are separate components separated from one another by an air gap.

4. The weighing station of claim 3, wherein the air gap is approximately 1 mm thick.

5. The weighing station of claim 2, wherein the first segment has slot formed in a bottom surface thereof to form a hinge between a first sub-portion and a second sub-portion of the first segment.

6. The weighing station of claim 5, wherein the second sub-portion is angularly rotatable about the hinge relative to the first sub-portion.

7. The weighing station of claim 6, wherein the slot extends from the bottom surface of the rail and terminates prior to the top surface of the rail.

8. The weighing station of claim 7, wherein the slot extends greater than half of an overall height of the rail.

9. The weighing station of claim 2, further comprising a shim situated under the at least one load cell within the cavity, the shim configured such that at least one the load cell is vertically adjustable relative to the rail.

10. The weighing station of claim 9, wherein the at least one load cell is vertically adjustable by the shim such that the load cell is operable to bias an end portion of the rail to a biased position higher than an unbiased position of the rail relative to the machine bed.

11. The weighing station of claim 2, wherein the at least one load cell includes two load cells situated on top of the machine bed and below the first segment of the rail.

12. A vertical load weighing station for a guide system, the weighing station comprising:
a machine bed;
a segmented rail mounted situated above the machine bed. at least one load cell disposed between a segment of the segmented rail and the machine bed; and
wherein the at least one load cell is operable to detect a vertical loading exerted upon the segment of the segmented rail.

13. The weighing station of claim 12, wherein the segmented rail is segmented such that it has at least a first and a second segment and the at least one load cell is positioned beneath the first segment.

14. The weighing station of claim 13, wherein the at least one load cell is situated in a cavity formed in the machine bed and wherein the at least first and second segments are separate components separated from one another by an air gap.

15. The weighing station of claim 14, further comprising a shim situated under the load cell within the cavity, the shim configured such that the load cell is vertically adjustable relative to the rail.

16. The weighing station of claim 13, wherein the first segment has slot formed in a bottom surface thereof to form a hinge between a first sub-portion and a second sub-portion of the first segment.

17. The weighing station of claim 16, wherein the second sub-portion is angularly rotatable about the hinge relative to the first sub-portion.

18. The weighing station of claim 13, wherein the at least one load cell includes two load cells positioned on a top surface of the machine bed.

19. A method for assembling a vertical load weighing station for a guide system, the method comprising the step of positioning at least one load cell beneath a rail mounted to a machine bed such that the at least one load cell is disposed between the rail and the machine bed, the rail configured to slidably support one or more trucks which in turn are configured to support a saddle of a machine, wherein the at least one load cell is positioned under the rail to detect a vertical loading upon the one or more trucks when the one or more trucks are positioned vertically above the load cell on the rail.

20. The method of claim 19, further comprising the steps of removing an existing portion of the rail to expose a portion of the machine bed, situating the at least one load cell on the machine bed, and replacing the existing portion of the rail such that the rail presents a generally continuous guide surface for guiding the one or more trucks.
